(19) United States
(12) Patent Application Publication
(10) Pub. No.: US 2016/0331002 A1
(43) Pub. Date: Nov. 17, 2016

(54) PALATE CLEANSING BEVERAGE AND METHOD OF MAKING AND USING THE SAME

(71) Applicant: SanTásti, Inc., Encinitas, CA (US)

(72) Inventors: Andrew MACALUSO, Encinitas, CA (US); Nicole Amy MACALUSO, Encinitas, CA (US)

(21) Appl. No.: 15/219,979

(22) Filed: Jul. 26, 2016

Related U.S. Application Data
(63) Continuation-in-part of application No. 12/098,984, filed on Apr. 7, 2008, now Pat. No. 9,427,015.

(51) Int. Cl. A23L 2/56; A23L 2/70; A23L 2/54; A23L 2/68; A23L 2/60

(52) U.S. Cl. CPC A23L 2/56; A23L 2/68; A23L 2/60; A23L 2/54; A23L 2/70; A23V 2002/00

(57) ABSTRACT

A beverage specifically designed for cleansing the palate, hereafter a palate cleansing beverage (“PCB”), is a carbonated beverage made of water, acidulats, polysaccharides, sweeteners, an astringent or bitter component or tannin removal additives, and carbonated components.

### FIELD

The field of the invention relates in general to cleansing the palate with foods and beverages.

### BACKGROUND

Ingestion of foods and beverages which cause palate fatigue can negatively affect subsequent ingestions. This is a concern for professionals in the beverage and food sectors as well as consumers in their general appreciation of sensory experiences. For example, winery tasting rooms may try to avoid the palate fatigue problem by pouring wines from white to red and lightest to heaviest astringencies. If unmitigated, this unavoidable problem combined with tasting order biases will have a substantial role on quality perception and therefore negatively misrepresent the product. Currently, the only approaches to solving palate fatigue include water, carbonated water, and crackers or bread. These options are readily available, but are not intended as palate cleansers. They may wash flavors away, but lack the ability to solve the entire problem.

Although inexpensive and portable, crackers and bread can be awkward to consume in between ingestions, leave particles on the palate, and lack the convenience and hydrating power of a beverage.

Often carbonated water may have such a high level of carbonation that it causes sensations of pain on the tongue which can negatively affect the sensory experience.

A need exists for a beverage that cleanses the palate and alleviates palate fatigue, allowing for accurate perception of multiple foods and beverages.

Palate fatigue is caused by adaptation—a change in sensitivity to a given stimulus as a result of continued ingestion of that stimulus or a very similar one. Palate fatigue is temporary, but can severely limit the ability to distinguish the stimulus in question. A major concern of wine, tea, beer, coffee or other beverage and food consumers and producers is the continual ingestion of chemical compounds known as tannins. Tannin is the general term used for any large molecular weight plant polyphenol that generally tastes both astringent and bitter when consumed. FIG. 3 is the base unit for most tannin compounds. Tannins are water soluble, have molecular weights in the 500-3000 range and can interact with proteins and polyamides due to the large quantities of hydroxyls and other such groups.

Astringency and bitterness are a sensation and basic taste respectively. Astringency is the puckering or dryness of the mouth that arises through the ingestion of tannic foods. This sensation is caused by salivary proteins precipitating as protein-tannin complexes, decreasing the lubricating effect of saliva. Bitterness is one of the five tastes that are received through taste buds: bitter, salty, sour, sweet, and umami. The two often go together in many beverages and foods: coffee, wine, tea, beer, fruits, legumes, condiments, etc. Although they may both be caused by tannins they are perceived differently and astringency often masks bitterness.

A palate cleanser is a food or beverage which helps to minimize any carryover or adaptation from one beverage or food to the next. In other words, it removes the stimulus that is causing or could cause palate fatigue without imparting any hindering flavors of its own or affecting the consumption of the subsequent food or beverage.

### SUMMARY

An aspect of the invention involves a beverage specifically designed for cleansing the palate, hereafter a palate cleansing beverage (“PCB”). The PCB is a carbonated beverage with ingredients that help to cleanse the palate. In an example embodiment, the ingredients include water, acidulants, polysaccharides, sweeteners, carbonation, and bitters or astringents or tannin removal additives. In an example embodiment, the ingredients include citric acid (an acidulant), pectin (a polysaccharide), sucrose (a sweetener), carboxymethyl cellulose sodium (polysaccharide or tannin removal additive), and carbon dioxide (carbonation). The combination and concentration of specific types of additives in various usage rates create a beverage that cleanses the palate without leaving behind any flavors or sensations that could affect subsequent ingestions. The additives in PCB are not limited to those above, but include any such compound that aids in neutralizing the palate, especially through the removal of tannins.

### BRIEF DESCRIPTION OF THE DRAWINGS

The accompanying drawings, which are incorporated in and form a part of this specification, illustrate the logic flow of the invention and its embodiments, and together with the description, serve to explain the principles of this invention.

FIG. 1 is a flow chart of an exemplary method for making the palate cleansing beverage.

FIG. 2 is a flow chart of an exemplary method of using the palate cleansing beverage.

FIG. 3 is a base unit of most tannin compounds.

FIG. 4 is an illustration of a palate balance equation.

FIG. 5 is an illustration of different taste perceptions.

FIG. 6 is an illustration of sensory analysis for a tasting experience.

FIG. 7 is a diagram of a palate buffering graph.

FIG. 8 is a diagram of component ranges for ingredients of a palate cleansing beverage.

### DETAILED DESCRIPTION

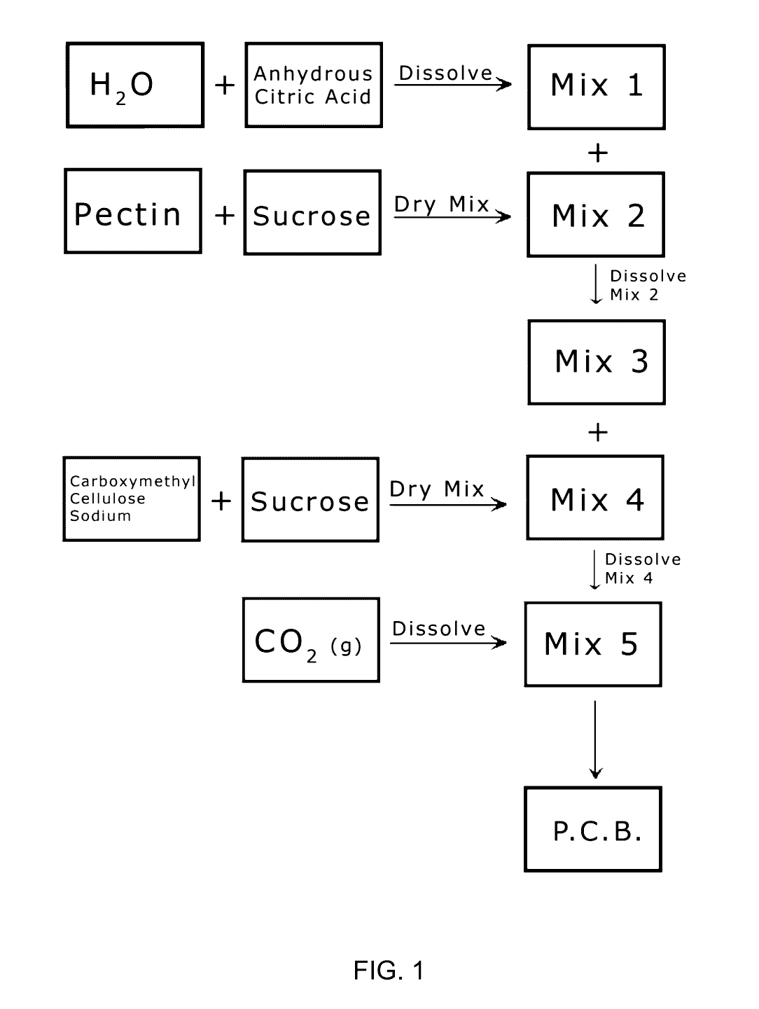

With reference to FIG. 1, a method of manufacturing a palate cleansing beverage (“PCB”) will now be described. As used herein, the term “beverage” can refer to a beverage composition which is in a single-strength, ready-to-serve, drinkable form. Beverages according to embodiments described herein can include at least 80% (or at least 85%) water. As used herein, a “tannin removal additive” means one or more additives that form complexes with tannin compound(s) (negatively charged polyphenols with high molecular weights), effectively removing the tannin compound(s) from the mouth.

Different example PCBs are described herein. The method of manufacturing one example PCB will now be described. The additives shown in FIG. 1 are mixed in the order shown for production and tactile reasons.

First, anhydrous citric acid is dissolved in water to form Mix 1. Manufacture of the PCB starts with purified water as a foundation for a PCB due to its neutrality and hydration ability. Water is used as a polar solvent to dissolve polar compounds. Anhydrous citric acid is added to lower the pH as well as to increase saliva production which further aids in palate cleansing. The citric acid is dissolved first as it does so easily and does not affect subsequent additions.

Second, pectin is dry mixed with sucrose producing a dry Mix 2 in order to facilitate rapid hydration. The pectin is an example tannin removal additive. Pectin has the ability to form complexes with tannin compounds (negatively charged polyphenols with high molecular weights), thus effectively removing them from the salivary proteins. Sucrose is added to balance the needed acid and other flavors from food additives.

Third, dry Mix 2 is dissolved in Mix 1 to form Mix 3.

Fourth, carboxymethyl cellulose sodium is dry mixed with sucrose to form dry Mix 4 for rapid hydration, but is added after the pectin so as to minimize any increases in viscosity that this additive can cause. Carboxymethyl cellulose sodium, or cellulose gum, is a polysaccharide. The polysaccharide is also a tannin removal additive and is incorporated for its ability to form complexes with tannin compounds (negatively charged polyphenols with high molecular weights), thus effectively removing them from the salivary proteins.

Finally, fifth, the beverage is carbonated last because agitation of the additives during mixing is not conducive to maintaining carbonation in production. Carbon dioxide produces carbonation in the beverage which helps to normalize the viscosity as well as produce carbonic acid which provides balance for other flavors. The carbonation lends a familiar and pleasant mouthfeel while providing tactile scrubbing on the tongue and mouth.

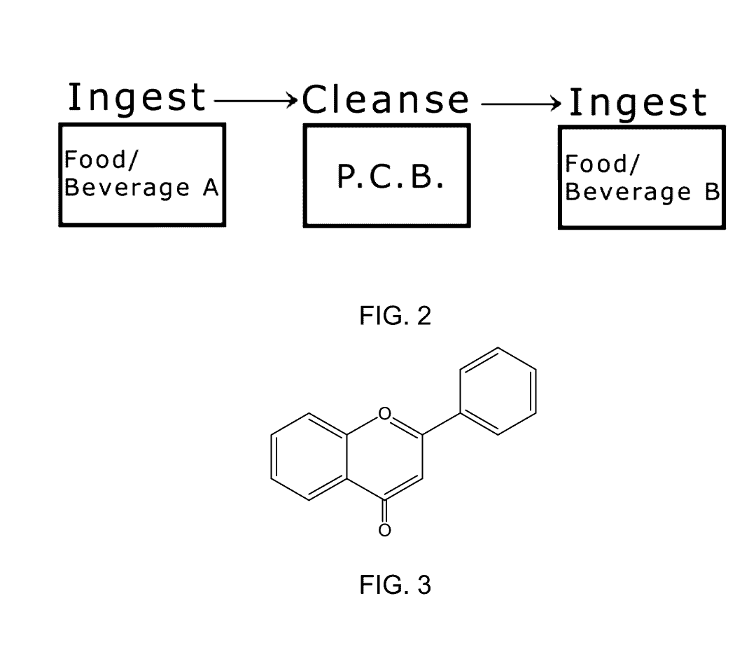

With reference to FIG. 2, a method of using the PCB for palate cleansing will be described. First, a first food and/or beverage is ingested, or tasted and expelled (e.g., wine tasting). Second, the PCB is ingested, or tasted and expelled. Finally, a second food and/or beverage is ingested, or tasted and expelled.

The PCB cleanses the palate significantly better than water or carbonated water alone. The PCB and method of use enables food/beverage customers and producers to experience the food or beverage as intended. They will be able to taste more flavors from more foods that palate fatigue would otherwise dull or conceal.

### Example Embodiment

The following is an embodiment of a beverage and method for making same. This is an illustrative example according to some embodiments and other example PCBs are provided herein.

The example PCB can be prepared as follows:
1. Citric acid 0.5 g/L is added to purified 1000 g water resulting in Mix 1.
   (a) The citric acid is stirred until completely dissolved.
2. Pectin 1 g/L is dry mixed with sucrose 2.5 g/L resulting in Mix 2.
3. Mix 1 is added to Mix 2 resulting in Mix 3
   (a) Mix 2 is stirred until completely dissolved in Mix 1
4. Carboxymethyl Cellulose Sodium 0.5 g/L is dry mixed with sucrose 2.5 g/L resulting in Mix 4.
5. Mix 4 is added to Mix 3 resulting in Mix 5.
   (a) Mix 4 is stirred until completely dissolved in Mix 3.
6. Mix 5 is then chilled to 40-50° F.
7. Mix 5 is then carbonated with CO₂.
   (a) The range of carbonation is 0.5 to 2.0 Volumes CO₂.
8. The resulting beverage is the PCB.
   (a) Note that the PCB is best served chilled.

As an example, the following ingredients were mixed together in the order and quantities indicated above to provide a beverage mix, Mix 5 (FIG. 1):

| Ingredient | Amount (g.) |
|---|---|
| Water | 1000 |
| Citric Acid (anhydrous) | 0.5 |
| Sucrose | 5.0 |
| Pectin | 1.0 |
| Carboxymethyl Cellulose Sodium | 0.5 |
| TOTAL | 1007.0 |

Variation of the usage rates and specific types of ingredients create different PCB products. For example, a PCB may include pectin and carboxymethyl cellulose sodium as the polysaccharide. The polysaccharide can also function as a tannin removal additive. In some example embodiments, a PCB may only include pectin as the polysaccharide and the tannin removal additive.

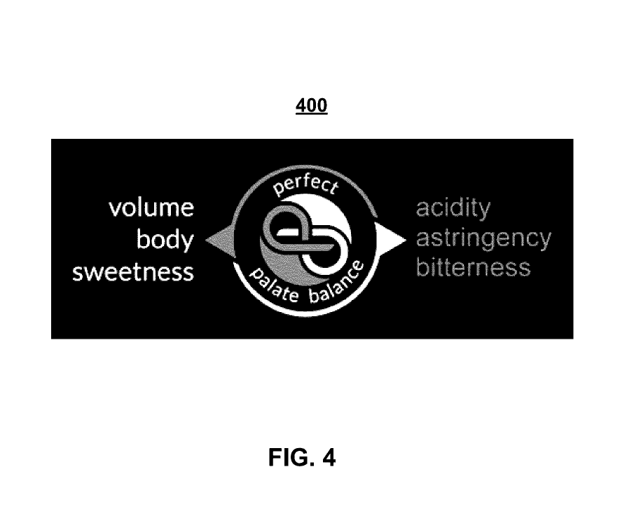

A PCB scientifically refreshes the palate. A PCB functions by buffering the palate's five tasting sensations (sweetness, saltiness, acidity, bitterness and umami) and the olfactory system to restore the overall sense of taste. A PCB is a beverage that restores the olfactory system's ability to perceive aromas. A PCB is a beverage that reduces the perception of chemesthesis sensations. As an illustrative example, a PCB is a beverage that can be mixed with wine to reduce the perception of chemesthesis without changing the taste. A PCB is a beverage that scientifically enhances the enjoyment of other foods by cleansing the palate. A PCB is a beverage that is capable of utilizing the Palate Balance Equation 400 (sweetness, volume, body in equilibrium with acidity, astringency and bitterness) shown in FIG. 4 to achieve these functions.

The sensation of taste can be categorized into five basic tastes: sweetness, sourness, saltiness, bitterness, and umami. Taste buds are able to differentiate among different tastes through detecting interaction with different molecules or ions. Sweet, umami, and bitter tastes are triggered by the binding of molecules to receptors on the cell membranes of taste buds.

The palates ability to perceive the five senses of taste in relation to one another can be governed by the Palate Balance Equation 400 shown in FIG. 4.

The Palate Balance Equation 400 represents an equilibrium of types of ingredients where one side of the equation directly affects the taste perception of the other side. For example, compounds such as polyphenols or tannins in a food or beverage cause an astringent reaction on the palate. Tannins precipitate with salivary proteins and cause a dry sensation on the palate, simultaneously changing the perceived tastes and the perceived mouthfeel of current and subsequent ingestions. These tannins in foods and beverages can decrease the perception of sweetness in the same way that sweetness can decrease the perception of tannins or bitter compounds.

Furthermore, sweetness can decrease the perception of acidity and likewise acidity can decrease the perception of sweetness and so on.

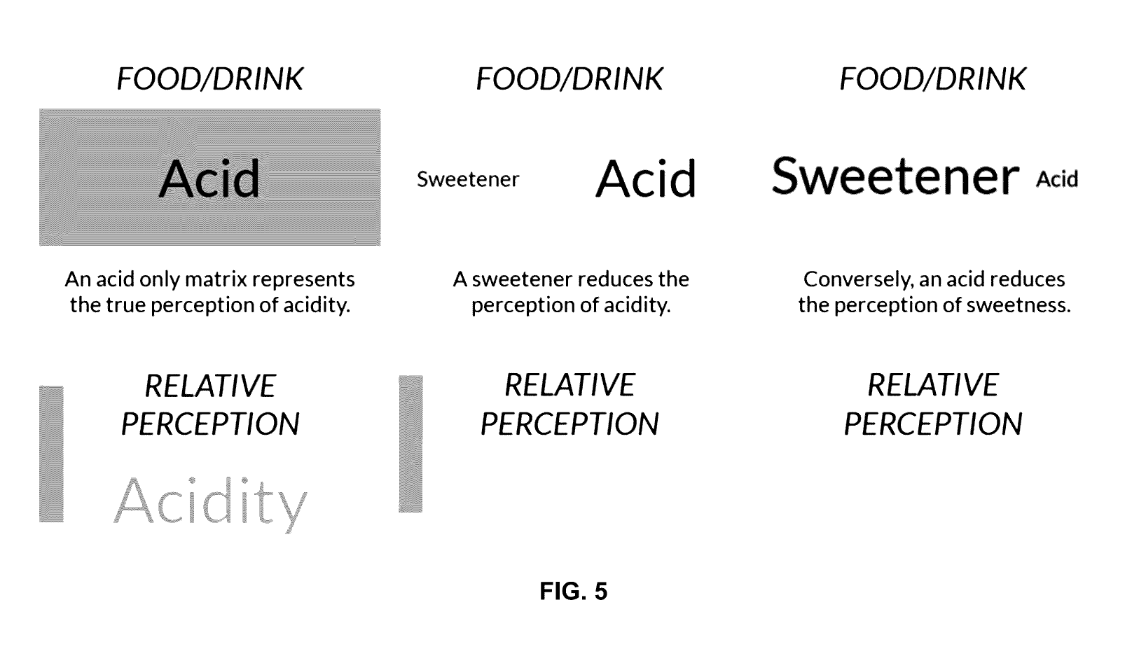

For example FIG. 5 shows of different taste perceptions including sweetness relative to acidity.

The basic tastes contribute only partially to the sensation and flavor of foods and beverages in the mouth. Another factor that contributes to the sensation and flavor of foods and beverages in the mouth include smell, detected by the olfactory epithelium of the nose. For example, the “taste” of a strawberry in the common vernacular is actually the smell of the strawberry in conjunction with the five senses of the palate. These aromatic receptors of the olfactory epithelium can get turned off after prolonged periods of stimulation. A new sensation or aroma can be introduced in order to reactivate these receptors. For example, professional tasters may use coffee beans as a means of resetting the ability to smell/taste other aromatic compounds.

Further factors that contributes to the sensation and flavor of foods and beverages in the mouth include texture (as detected through a variety of mechanoreceptors, muscle nerves, etc.); temperature (as detected by thermoreceptors); and “coolness” (such as of menthol) and “hotness” (spicy) through chemesthesis. For example, capsaicin is a chemical compound associated with spicy foods. The burning and painful sensations associated with capsaicin result from its chemical interaction with sensory neurons. Capsaicin, as a member of the vanilloid family, binds to a receptor called the vanilloid receptor, which can also be stimulated with heat, protons and physical abrasion. This permits cations to pass through the cell membrane when activated. The resulting depolarization of the neuron stimulates it to signal the brain. By binding to the receptor, the capsaicin molecule produces similar sensations to those of excessive heat or abrasive damage. This may explain why the spiciness of capsaicin is described as a burning sensation.

Sight also plays a major role in the perception of foods and beverages. For example, Pinot Noir winemakers can often use enzymes to extract more color from their grapes in order to achieve a deeper look for this relatively lightly colored wine. This is done to increase the perception of quality and taste. Sight is important in identifying beverages as well. With a blacked out glass, blindfolded wine drinkers have a hard time accurately discerning between red and white wines.

Further, taste and the sense of smell are closely linked to emotions. Both senses are connected to the involuntary nervous system. That is why a bad taste or odor can bring about vomiting or nausea. Flavors that are appetizing increase the production of saliva to cause mouthwatering. The overall tasting experience is directly related to emotion. A person who tastes something while happy or relaxed is more likely to enjoy their experience.

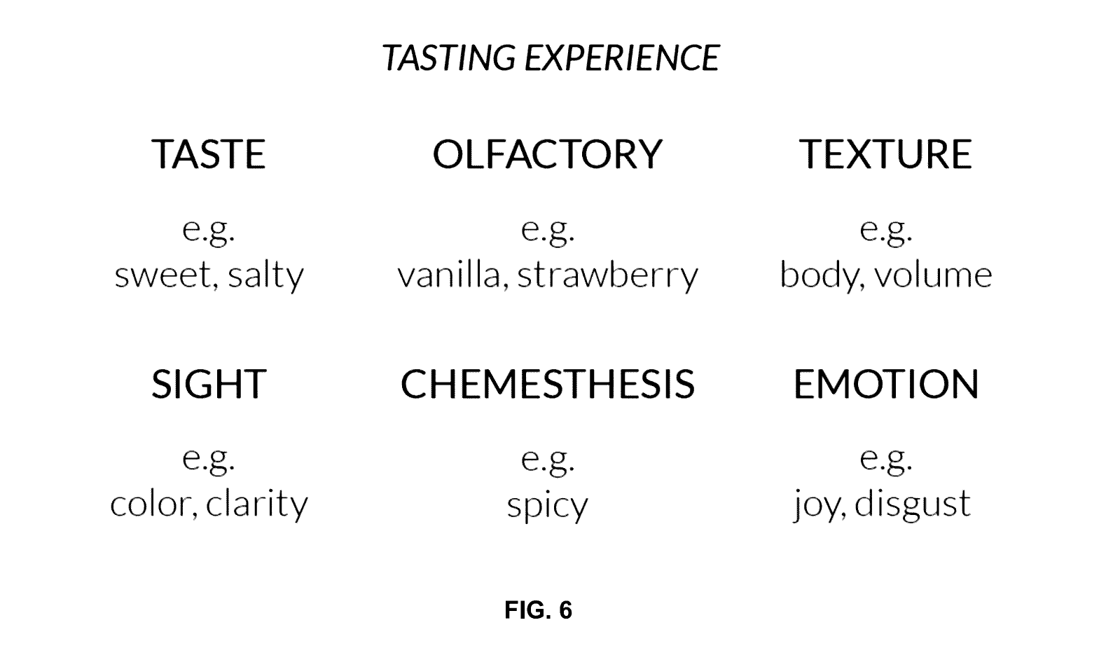

FIG. 6 is an illustration of sensory analysis for a tasting experience. Example factors that contribute to the tasting experience (sensation and flavor of foods and beverages in the mouth) include taste, olfactory, texture, sight, chemesthesis, and emotion.

With an understanding of sensory analysis and how taste, mouthfeel and smell works, embodiments described herein provide a beverage that aids in refreshing the palate and olfactory system to a state of neutrality by satisfying the entire palate balance equation including the five senses, olfactory senses and the texture perception of the palate including spiciness.

The ingredients of a Palate Cleansing Beverage (or PCB) work together in a synergistic way in a water solution to create the desired effects and benefits of cleansing the palate to restore a state of neutrality. The combinations of ingredients are cross-referential and physically balance each other's perceptions to restore the palate as well as function to neutralize the other components of the tasting experience.

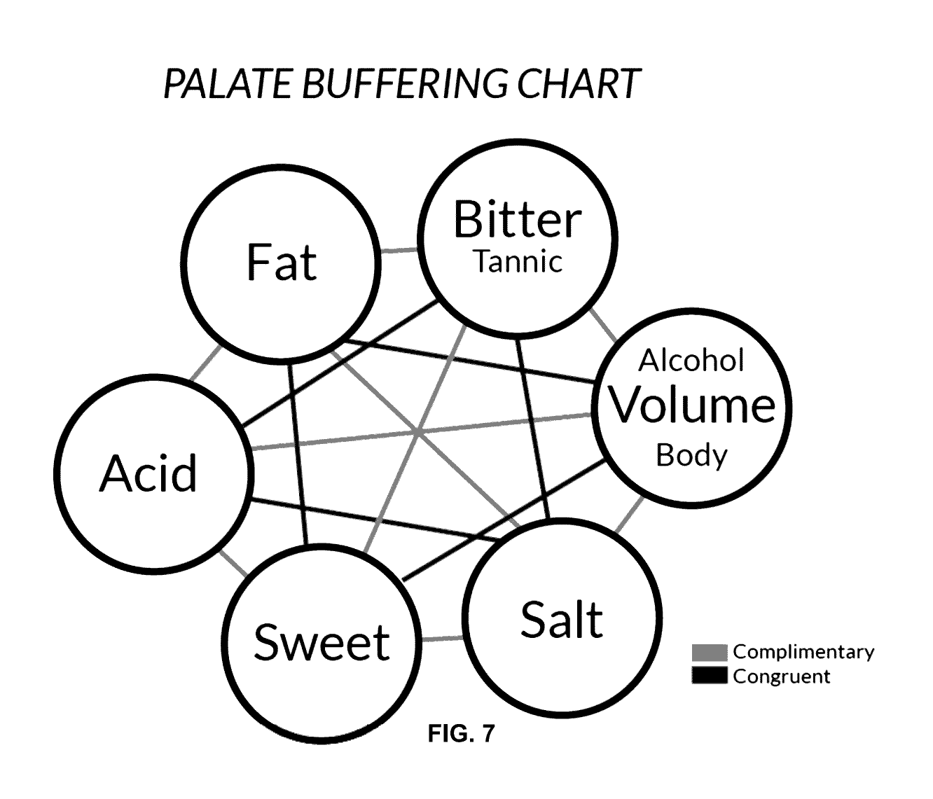

FIG. 7 is a diagram of a palate buffering graph or chart.

The Palate Cleansing Beverage includes water as a base solution. Water has a direct relationship to the other ingredients and appearance of the Palate Cleansing Beverage. Water is an excellent solvent for polar and ionic compounds. Tastes like saltiness are easily rebalanced by pure water. Water is a suitable medium for the blend of ingredients required to make a Palate Cleansing Beverage and the primary ingredient. In some embodiments, all of the ingredients used result in a clear and colorless liquid in order to not bias the users perception based on sight.

The Palate Cleansing Beverage includes acid as an ingredient. Acid has a direct relationship with sweeteners (another ingredient in the Palate Cleansing Beverage).

In some embodiments, Palate Cleansing Beverage includes an acid, like citric acid component, to stimulate saliva flow and replace lost saliva. The Palate Cleansing Beverage includes a sweetener to balance against this acid and satisfy the Palate Balance Equation (FIG. 4). The Palate Cleansing Beverage includes a slightly bitter and astringent component, like ascorbic acid, to lightly stimulate bitter receptors on the palate and fully balance the perception of volume, body and sweetness.

The acid component and the sweetener component has a direct relationship with textures and chemesthesis. The level and variety of the acid component required to create the desired effects of stimulating saliva flow require a high level of sweetness that can linger without any other source of volume and body to fully balance the equation. The beverage would not function to refresh the palate with lingering tastes like sweetness or bitterness. In wine, sources of sweetness are more than just from residual sugar, but also from alcohol and other polysaccharides that add volume and body. Body is a term used to describe the general weight, ‘fullness’ or overall feel of a liquid in the mouth. By stimulating saliva flow, fresh saliva aids in reducing chemesthesis effects.

The Palate Cleansing Beverage includes a polysaccharide component that has a direct relationship with the sweeteners, acid component and the texture and chemesthesis of the beverage. Polysaccharides are used to create gels in high sugar content foods. With a combination of a sweetener (like sugar), and a polysaccharide (like fruit pectin) a beverage is capable of having more body and volume than it otherwise would get from large amounts of sugar. This body adds to the perceived satisfaction of consuming a Palate Cleansing Beverage, while greatly reducing the number of calories in the beverage and allowing the balance of taste between acid and sweetness to be achieved with limited to no aftertaste.

Furthermore, the use of a polysaccharide, like pectin, provides a mechanism to remove certain compounds from the palate, like tannins or bitter compounds from salivary proteins. That is, a polysaccharide can also function as a tannin removal additive. The polysaccharide also works to provide lubrication that is lost from astringent compounds, and other foods, allowing the user to experience a more neutral texture state of the palate. The use of a sweetener, like sucrose, and an acid component, like citric acid, further reduces the burning sensation of capsaicin on the palate. Other compounds that mitigate specific or multiple chemesthesis responses could also be used. For example, a milk protein such as casein binds to capsaicin and washes it away.

As a further example, ethanol causes a similar chemesthesis response as capsaicin. Ethanol also activates the neural pathway associated with sweetness and tastes slightly sweet. The burning sensation from a strong alcoholic beverage can be offset, much like that from capsaicin, with the use of another sweetener in conjunction with an acid component. Traditional cocktail mixers aim to achieve this effect of a reduced burning sensation through large amounts of sugar and acid. In contrast, a Palate Cleansing Beverage according to embodiments described herein uses the combination of a sugar, an acid and a polysaccharide while maintaining the palate balance equation makes a functioning mix that reduces the level of the burning sensation without having to add as much sugar. This effect is magnified by the polysaccharide component which allows the Palate Cleansing Beverage to have much less sugar than a traditional cocktail. Benefits include a lower calorie and naturally sweetened mixer.

A PCB is a beverage that can be mixed with wine to reduce the perception of chemesthesis while maintaining the taste of the wine. The PCB is essentially a blank wine. Wine has a pH, sweetness and body range that is similar or identical to that of a PCB according to some embodiments. Essentially, a PCB can be mixed with wine with minimal to no changes to the resulting mixture's pH, residual sugar, body or taste. The benefit of this is a greatly reduced chemesthesis response and lower calorie per volume cocktail that maintains the taste of the wine.

The Palate Cleansing Beverage includes a carbonated component and aromatics. The carbonation of the Palate Cleansing Beverage has a direct relationship with aromatics and sweeteners. The aromatics of the Palate Cleansing Beverage has a direct relationship with Olfactory Senses.

Carbonation and natural aromatic compounds are used to achieve the desired olfactory results and restore the ability to sense other aromatic compounds. Carbonation is required to volatilize the aromatic compounds used in a Palate Cleansing Beverage to reset the olfactory senses. With this increased volatility of aromatics their perceived flavor is greatly increased, allowing the flavor to be strong enough to help reset the olfactory senses without leaving behind a lingering aftertaste from oils on the palate. Carbonation, along with the various acids (such as for example, carbonic acid, citric acid and ascorbic acid), act as a preservative to protect the Palate Cleansing Beverage from microbial spoilage and oxidation. A sweetener and polysaccharide combination is required to offset the perception of the carbonic acid that is produced by the carbonation. Furthermore, carbonation provides a physical scrubbing of the palate.

The overall formulation and packaging of the Palate Cleansing Beverage can relate to emotion of the consumer. When intended for increasing the enjoyment of foods the Palate Cleansing Beverage's formulation, packaging and appearance can have a direct effect on the user's emotions. For example, vibrant packaging colors, healthful ingredients and other chemical compounds and ingredients that are known to alter one's mood towards a more relaxed state can be used to further enhance the user's experience.

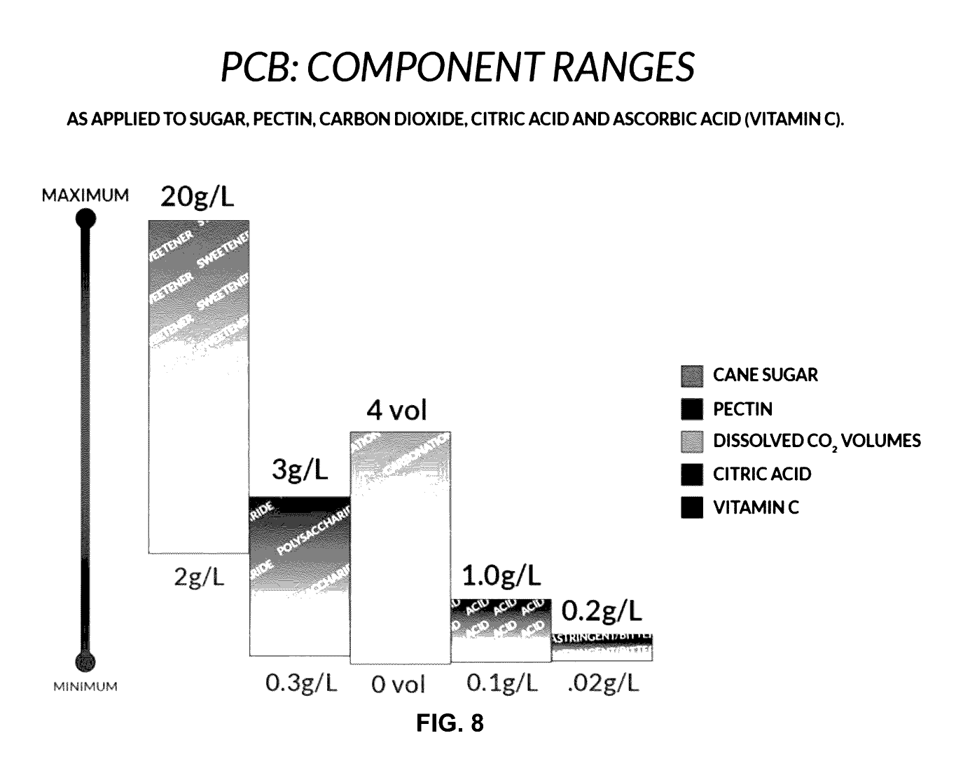

FIG. 8 is a chart of ingredient or component ranges of the Palate Cleansing Beverage according to some embodiments. The example chart specifies ranges of each component of the Palate Cleansing Beverage as it applies to a specific embodiment. The example embodiment uses sugar as the sweetener, pectin as the polysaccharide, citric acid as the acidulant (or acid component), carbon dioxide as the carbonation, and vitamin C as the astringent/bitter component.

The Palate Cleansing Beverage can include quantities of ingredients based on approximate range of 0.1 g/L to 1.0 g/L of the acidulant, 2 g/L to 20 g/L of the sweetener, 0.3 g/L to 3 g/L of the polysaccharide, 0 volumes to 4 volumes of the carbonation component, and 0.02 g/L to 0.2 g/L of the astringent and bitter component.

In some example embodiments, the polysaccharide also acts as a tannin removal additive. For example, a polysaccharide can be pectin which can also function as a tannin removal additive.

The unit measurement of the ingredients is in grams of ingredient per liter of water. For example, where it shows 2 g/L of cane sugar that would be 2 g of cane sugar dissolved in 1 liter of water. The PCB can be made with various amounts of water.

To summarize, a Palate Cleansing Beverage provides the user with a beverage that by physical and chemical means aids in resetting the olfactory senses, rebalances the palate's five senses of taste, relubricates the palate, reduces sensations caused by chemesthesis, scrubs the palate physically, leaves little to no aftertaste and restores the palate to the neutral state of the Palate Balance Equation.

The description and figures may depict exemplary configurations, compositions, and methods for various embodiments, which is done to aid in understanding the features and functionality that can be included in the invention. The invention is not restricted to the illustrated configurations, compositions, and methods, but can be implemented using a variety of alternative configurations, compositions, and methods. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A palate cleansing beverage, with ingredients comprising:
water;
an acidulant to lower pH as well as increase saliva production;
a sweetener to balance the acidulant and other flavors from food additives;
a polysaccharide component as one or more tannin removal additives to form complexes with one or more tannin compounds;
an astringent and bitter component; and
carbonated components to produce carbonation, provide tactile scrubbing on the tongue and mouth, and produce carbonic acid, wherein quantities of the ingredients are based on approximate range of, 0.1 g/L to 1.0 g/L of the acidulant, 2 g/L to 20 g/L of the sweetener, 0.3 g/L to 3 g/L of the polysaccharide, 0 volumes to 4 volumes of the carbonation component, and 0.02 g/L to 0.2 g/L of the astringent and bitter component.

2. The palate cleansing beverage of claim 1 wherein the acidulant is citric acid.

3. The palate cleansing beverage of claim 1 wherein the sweetener is sucrose.

4. The palate cleansing beverage of claim 1 wherein the polysaccharide is pectin.

5. The palate cleansing beverage of claim 1 wherein the carbonation component is dissolved carbon dioxide.

6. The palate cleansing beverage of claim 1 wherein the astringent and bitter component is vitamin C or ascorbic acid.

7. The palate cleansing beverage of claim 1 wherein the polysaccharide also provides a tannin removal additive.

8. The palate cleansing beverage of claim 4 wherein the polysaccharide further comprises carboxymethyl cellulose sodium.

9. A method of manufacturing a palate cleansing beverage, using ingredients comprises:
dissolving anacidulant in water to form an acid and water mix;
dissolving a polysaccharide and sweetener mix into the acid and water mix;
dissolving astringent and bitter component and additional sweetener dry mix into the polysaccharide, sweetener, acid, and water mix; and
carbonating, using a carbonation component, the astringent and bitter component, the polysaccharide, sweetener, acid, and water mix to form the palate cleansing beverage wherein quantities of the ingredients are based on an approximate range of 0.1 g/L to 1.0 g/L of the acidulant, 2 g/L to 20 g/L of the sweetener, 0.3 g/L to 3 g/L of the polysaccharide, 0 volumes to 4 volumes of the carbonation component, and 0.02 g/L to 0.2 g/L of the astringent and bitter component.

10. The method of manufacturing a palate cleansing beverage of claim 9 wherein the acidulant is citric acid.

11. The method of manufacturing a palate cleansing beverage of claim 9 wherein the sweetener is sucrose.

12. The method of manufacturing a palate cleansing beverage of claim 9 wherein the polysaccharide is pectin.

13. The method of manufacturing a palate cleansing beverage of claim 9 wherein the carbonation component is dissolved carbon dioxide.

14. The method of manufacturing a palate cleansing beverage of claim 9 wherein the astringent and bitter component is vitamin C or ascorbic acid.

15. The method of manufacturing a palate cleansing beverage of claim 9 wherein the polysaccharide also functions as a tannin removal additive.

16. A method of cleansing one's palate, which comprises:
at least one of ingesting and tasting at least one of a first food and a first beverage;
at least one of ingesting and tasting the palate cleansing beverage of claim 1 to cleanse one's palate; and
at least one of ingesting and tasting at least one of a second food and a second beverage.

17. A palate cleansing beverage, with ingredients comprising:
water;
an acidulant to lower pH as well as increase saliva production;
a polysaccharide component to form complexes with tannin compounds;
a sweetener to balance the acidulant and other flavors from food additives;
the polysaccharide component to provide tannin removal additives to form complexes with tannin compounds; and
a carbonated component to produce carbonation, provide tactile scrubbing on the tongue and mouth, and produce carbonic acid wherein quantities of the ingredients are based on approximate ratios described herein.

18. The palate cleansing beverage of claim 17 wherein the acidulant is citric acid.

19. The palate cleansing beverage of claim 17 wherein the polysaccharide is pectin.

20. The palate cleansing beverage of claim 17 further comprising an astringent and bitter component such as vitamin C or ascorbic acid.
